(19) United States
(12) Patent Application Publication
(10) Pub. No.: US 2006/0284985 A1
(43) Pub. Date: Dec. 21, 2006

(54) Remote instruction system and method thereof

(75) Inventor: Kiwame Tokai, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/334,411

(22) Filed: Jan. 19, 2006

(30) Foreign Application Priority Data
Jun. 16, 2005 (JP) 2005-175831

(51) Int. Cl. H04N 5/232

(52) U.S. Cl. 348/211.99

(57) ABSTRACT

A remote instruction system includes a controller that controls an image capturing portion to continue capturing an image of a target to transmit a captured image to a remote terminal with the image of the target being captured, and controls a projecting portion to project onto the target an annotation image according to an instruction on the captured image given by the remote terminal, and a duplicated image creating portion that creates a duplicated image of the target on the basis of the captured image of the target to be used as the annotation image.

### BACKGROUND OF THE INVENTION

1. Field of the Invention

This invention relates to a remote instruction system in which it is possible to make an instruction remotely by means of an image.

2. Description of the Related Art

In a remote repair system, remote maintenance system, remote medical care system, remote conferencing, and the like, for example, various instructions in operation procedure need to be given to a real thing from a remotely located position. As one of remote instruction systems where the instructions can be given to the real thing from the remote location, for example, U.S. Patent Application Publication No. 2004-0070674 describes a technique of sending a moving image to a remote terminal while a target existent on the real thing side is being captured by a camcorder, and projecting an annotation image onto the target by means of a projector on the real thing side, the annotation image being designated on the basis of the captured image on the remote terminal.

In the above-described remote instruction system, rendering signals for forming the annotation image are limited to those prepared in the remote location. For this reason, there is a limitation to the kind and content of the annotation image that can be drawn to some extent, and there is a possibility that the instruction cannot be given appropriately to the target from the remote location by the annotation image only. In such a case, another instruction by means of voice or the like is needed other than the image, increasing a workload on the remote location. Therefore, there is a possibility that the work instruction cannot be given efficiently

### SUMMARY OF THE INVENTION

The present invention has been made in view of the above circumstances and provides a remote instruction system in which a captured image of a target is transmitted to a remote terminal and an annotation image is projected onto the target according to an instruction on the captured image given by the remote terminal, so that the instruction with the annotation image can be given appropriately and the instruction can be facilitated.

According to one aspect of the present invention, there may be provided a remote instruction system including; a controller that controls an image capturing portion to continue capturing an image of a target to transmit a captured image to a remote terminal with the image of the target being captured, and controls a projecting portion to project onto the target an annotation image according to an instruction on the captured image given by the remote terminal; and a duplicated image creating portion that creates a duplicated image of the target on the basis of the captured image of the target to be used as the annotation image. With the afore-described configuration, the captured image captured y the image capturing portion can be utilized as the annotation image, increasing the substantial kinds and contents of the annotation image. This makes it possible to appropriately give an instruction and facilitate the instruction from a remote location.

According to another aspect of the present invention, there may be provided a remote instruction method including: controlling an image capturing portion to continue capturing an image of a target to transmit a captured image to a remote terminal with the image of the target being captured; controlling a projecting portion to project onto the target an annotation image according to an instruction on the captured image given by the remote terminal; a duplicated image creating portion that creates a duplicated image of the target on the basis of the captured image of the target; and creating a duplicated image of the target on the basis of the captured image of the target to be used as the annotation image.

### BRIEF DESCRIPTION OF THE DRAWINGS

Embodiments of the present invention will be described in detail based on the following figures, wherein:

FIG. 1 is a block diagram showing an embodiment in accordance with a remote instruction system of the present invention;

FIG. 2 is a flowchart showing an example of process on a computer of the remote terminal;

FIG. 3 is a flowchart showing an example of process on the server on the target end apparatus;

FIG. 4 is a flowchart showing an example of control signal processing shown in FIG. 3;

FIGS. 5A through 5C are views illustrating the duplicated image projected onto the target;

FIGS. 6A and 6B are views illustrating examples of instruction operation on the remote terminal; and

FIGS. 7A and 7B are views illustrating examples of instruction operation on the remote terminal.

### DESCRIPTION OF THE EMBODIMENTS

A description will now be given, with reference to the accompanying drawings, of embodiments of the present invention.

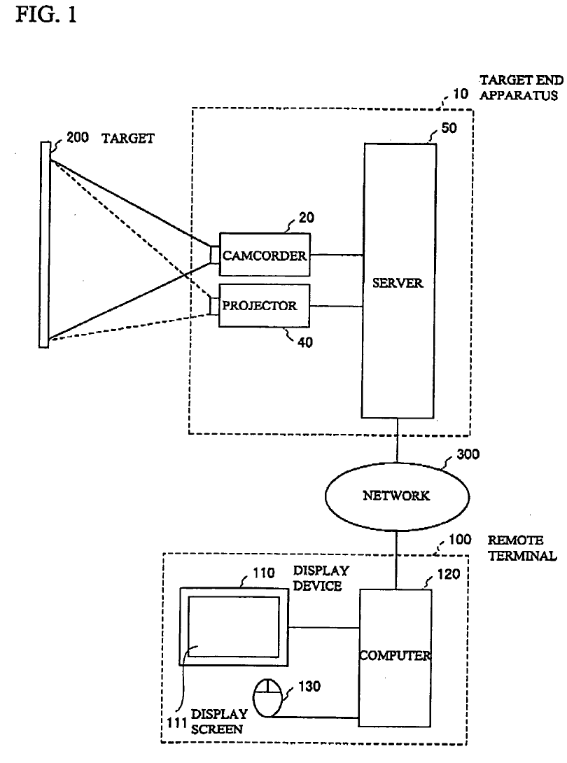

FIG. 1 is a block diagram showing an embodiment in accordance with a remote instruction system of the present invention. In the remote instruction system, there are provided a target end apparatus 10 and a remote terminal 100, as shown in FIG. 1. The target end apparatus 10 and the remote terminal 100 are connected via a network 300 so that they can communicate with each other. Only one remote terminal 100 is shown in FIG. 1, yet multiple remote terminals 100 can be connected to a server 50 on the target end apparatus 10, as will be described later, via the network 300. In the present embodiment, a description will be given of a case where a white board is exemplified as a target 200.

The target end apparatus 10 includes a camcorder 20 that serves as an image capturing portion, a projector 40 that serves as an image projecting portion, and the server 50 that serves as a controller.

The camcorder 20, for example, is composed of a CCD camera and installed in a position that can capture the target 200, and such captured image is taken into the server 50.

The projector 40 is adjacently arranged to the camcorder 20, and a field angle thereof is arranged to be substantially aligned with that of the camcorder 20. A liquid crystal projector or the like is employed for projector 40.

The server 50 controls the operation of the camcorder 20 and that of the projector 40, and in addition, sends and receives various types of information to and from the remote terminal 100 via the network 300. Also, the server 50 transmits the captured image being captured by the camcorder 20 to the remote terminal 100, and in addition, controls the projector 40 to project an annotation image onto the target 200, according to the instruction on the captured image given by the remote terminal 100. Furthermore, the server 50 controls the projector 40 to project a duplicated image of the target 200 based on the captured image of the target 200, onto the target 200 as an annotation image. With respect to the duplicated image, the server 50 controls to change an exposure condition of the camcorder 20 so that the duplicated image projected onto the target 200 can be recognized and distinguished between a normal image capturing time when the target 200 is captured by the camcorder 20 and a duplicated image capturing time when the target 200 is captured to create the duplicated image. Here, an exposure control process of the camcorder 20 will be described later in detail The annotation image may be any type of image such as line, character, drawing, and the like.

The remote terminal 100 includes a display device 110 such as a crystal liquid device, CRT, or the like, a computer 120 connected to the network 300, and a pointing device (mouse) 130 connected to the computer 120. A display device 110 displays the image transmitted from the target end apparatus 10 on the display screen thereof. The pointing device (mouse) 130 is used for forming the instruction on the annotation image to be projected onto the target 200, by manipulating various buttons or the like with a pointer on the display screen on which the captured image is being displayed.

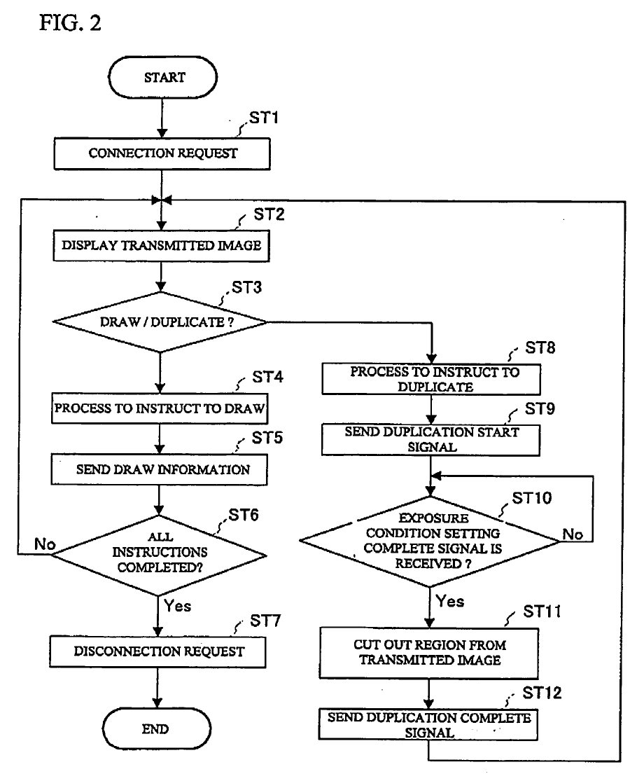

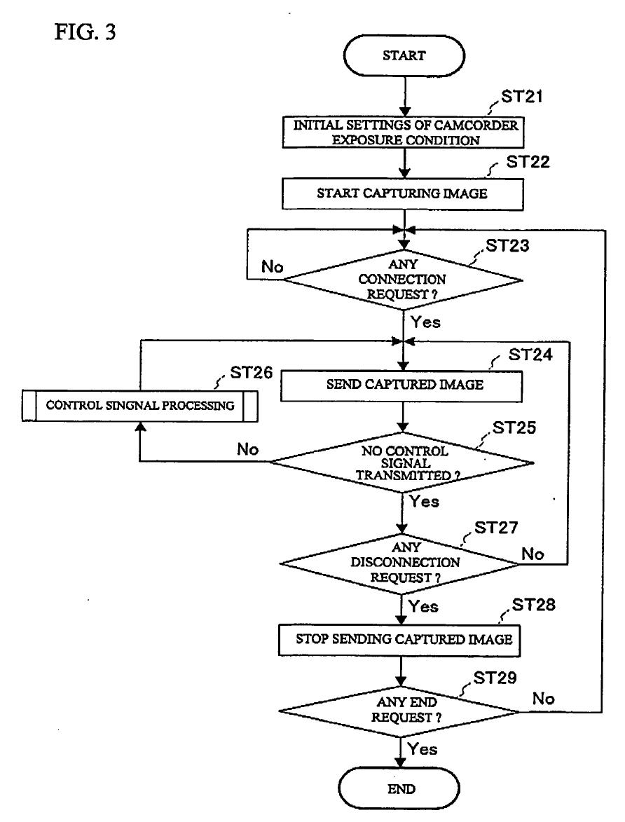

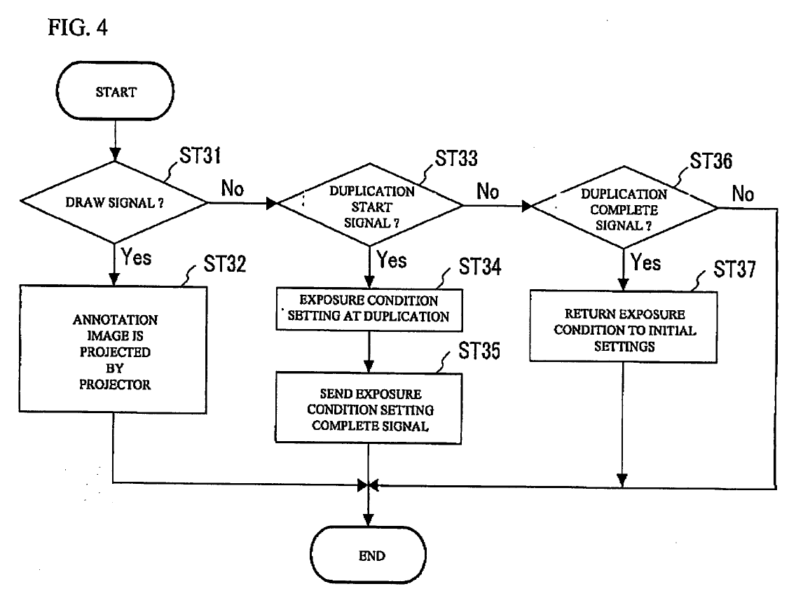

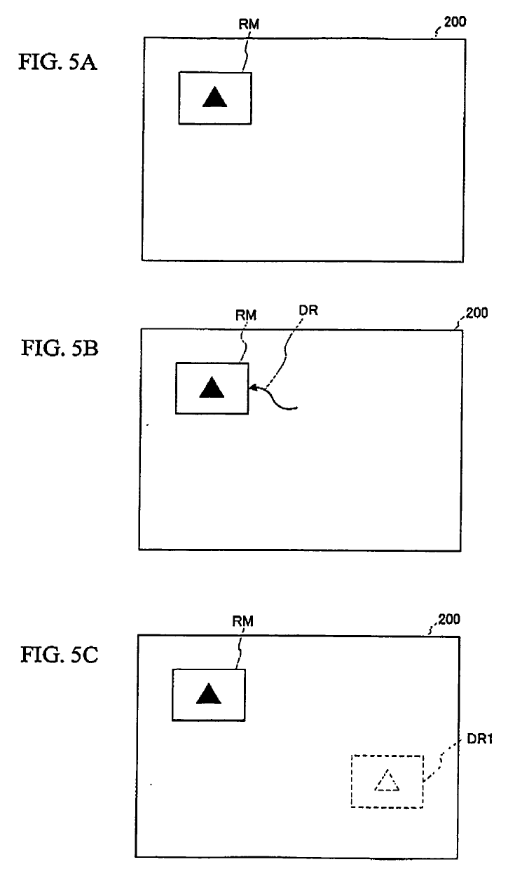

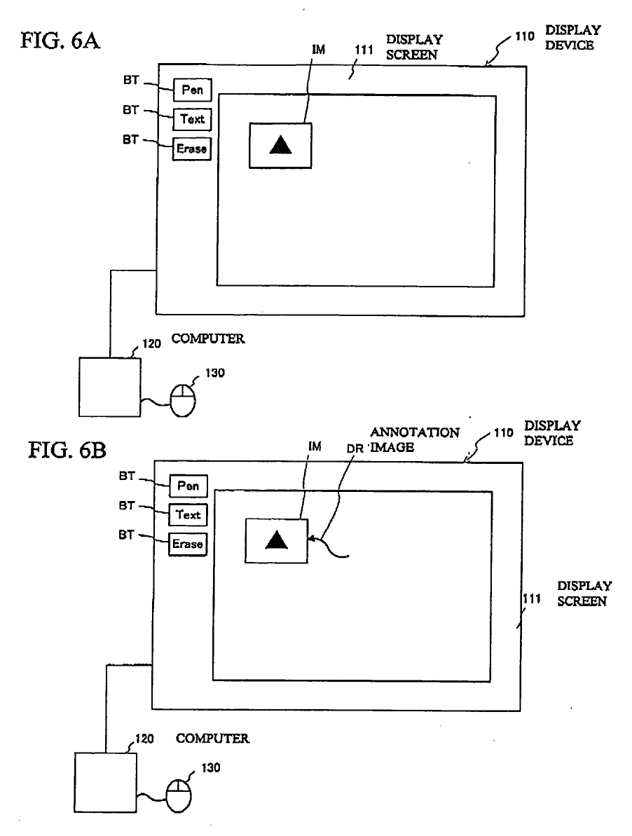

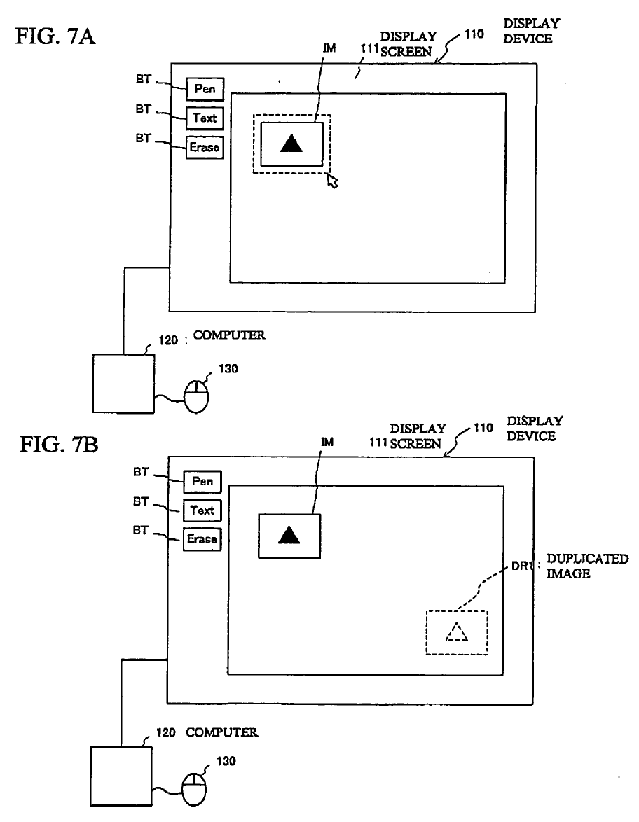

Next, a description will be given, with reference to FIG. 2 through FIG. 6, of operations of the remote instruction system having the above-described configuration. FIG. 2 is a flowchart showing an example of process on a computer of the remote terminal. FIG. 3 is a flowchart showing an example of process on the server on the target end apparatus. FIG. 4 is a flowchart showing an example of control signal processing shown in FIG. 3. FIGS. 5A through 5C are views illustrating the duplicated image projected onto the target. FIGS. 6A and 6B and FIGS. 7A and 7B are views illustrating examples of instruction operation on the remote terminal.

First, the process of the computer 120 on the remote terminal 100 will be discussed. Referring to FIG. 2, the computer 120 issues a connection request to the server 50 of the target end apparatus 10 (step ST1). Next, after the connection is established with the server 50, the computer 120 displays the captured image of the target 200, which has been sent from the server 50, on a display screen 111 of the display device 110 (step ST2). At this time, referring to FIG. 5A, for example, if something like a notice RM is attached on the target 200 that is a white board, the image of the white board that includes an image IM is displayed on the display screen 111 of the display device 110, as shown in FIG. 6A. The image IM denotes an image of the notice RM. In addition, the display screen 111 simultaneously displays various buttons BT provided for selecting and manipulating to give instructions of drawing the annotation image or the like. Here, the notice RM partially composes the target 200.

Subsequently, the computer 120 determines whether the operator of the remote terminal 100 has given an instruction of drawing the annotation image or creating the duplicated image of the target 200 (step ST3). If the computer 120 determines that the instruction has been given to draw the annotation image or the like, the remote terminal 100 implements a process of drawing the annotation image as instructed by the operator (step ST4). In giving the instruction of drawing, for example, the operator gives an instruction of a noteworthy region, while manipulating the pointing device 130 and moving a pointer Pt on the display screen 111. The noteworthy region is a region that defines a projection region onto which the annotation image is projected. At this time, another instruction on information on the annotation image to be projected onto the noteworthy region is simultaneously given. The information on the annotation image includes graphic information, a bitmap image prepared in advance, text information input by the keyboard, the pointer that reflects the operation of the pointing device 130, and the like. The graphic information denotes a rectangle or circle to be drawn by manipulating the various buttons BT or the like provided on the display screen 111, with the use of, for example, the pointing device 130. For instance, if the operator of the remote terminal 100 likes to indicate or annotate the notice RM with the annotation image, the operator manipulates to give an instruction so that the annotation image DR is displayed on the display screen 111, as shown in FIG. 6B, for example.

Then, the computer 120 transmits the various types of information specified in step ST4 to the server 50, as a draw signal (step ST5). When the draw signal relating to the annotation image DR is transmitted to the server 50, the annotation image DR, as shown in FIG. 5B, is projected onto the target 200 by the projector 40. The captured image of the target 200 is displayed on the display screen 111 of the remote terminal 100 as the image that includes the annotation image DR, as shown in FIG. 6B.

Next, the computer 120 determines whether the instruction of drawing the annotation image has been completed (step ST6). If not, processing goes back to step ST2 to repeat the above-described processes. If completed, the computer 120 issues a disconnection request to the server 50 in the target end apparatus 10.

If the computer 120 determines that an instruction of creating the duplicated image of the target 200 has been given, a process relating to the operator's instruction of creating the duplicated image is implemented (step ST8). If the operator of the remote terminal 100 likes to duplicate, for example, the image of the notice RM that partially composes the target 200, the operator of the remote terminal 100 indicates the duplicated region of the image IM of the notice RM shown on the display screen 111, as shown in FIG. 7A. Subsequently, the computer 120 receives the above-mentioned operator's instruction, and transmits a duplication start signal to the server 50 (step ST9). The duplication start signal is a signal for notifying the server 50 of the start of the image duplication. As will be described later, upon receiving the duplication start signal, the server 50 changes the exposure condition of the camcorder 20 for the image duplication.

Subsequently, the computer 120 determines whether an exposure condition setting complete signal has been received from the server 50 (step ST10). The exposure condition setting complete signal, as will be described later, is a signal notifying that the exposure condition of the camcorder 20 has been changed to those for duplication, when the duplication image was created. The computer 120, upon receiving the exposure condition setting complete signal, changes the exposure condition and cuts out the image of the duplication region specified in step ST8 with the captured image captured by the camcorder 20 (step ST11). This completes the formation of the duplicated image. For instance, when the image IM of the notice RM is cut out, the image IM is stored on a memory of the computer 120 as a bitmap image to be used for the annotation image.

When the computer 120 completes creating the duplicated image, a duplication complete signal is transmitted to the server 50 (step ST12). At this time, the duplicated image of the notice RM formed on the computer 120 is to be projected onto the target 200 as the annotation image, the duplicated image of the notice RM is selected in step ST3, and the draw signal of the duplicated image of the notice RM is transmitted to the server 5 and the duplicated image DR1 of the notice RM is projected onto the target 200, as shown in FIG. 5C, for example. The captured image of the target 200 that includes the duplicated image DR1 of the notice RM is transmitted to the computer 120 and displayed on the display screen 111 of the remote terminal 100, as shown in FIG. 7B, for example.

Now, the process implemented by the server 50 will be described. Referring to FIG. 3, first, initial settings of the exposure condition are implemented for the camcorder 20 (step ST21). As an example of the initial settings of the exposure condition for the normal image capturing, automatic exposure control is set to operate in the camcorder 20. Here, the automatic exposure control is a function that adjusts the iris diaphragm in the lens, shutter speed, and the like, so that the brightest portion captured by the camcorder 20 may be shown as bright as possible. As described heretofore, the exposure is changed according to the brightness of the image to be projected onto the target 200, by utilizing the automatic exposure control in the camcorder 20, enabling the target 200 to be captured in a most suitable situation.

Then, the server 50 starts importing the image being captured by the camcorder 20 (step ST22). The sever 50 determines whether there is a connection request from the computer 120 of the remote terminal 100 (step ST23). If there is a connection request from the computer 120, the server 50 sends the captured image being captured by the camcorder 20 to the computer 120 in the remoter terminal 100 via the network 300 (step ST24).

The server 50 determines whether a control signal has been transmitted from the computer 120 in the remote terminal 100 (step ST25). This control signal is composed of the draw signal, the duplication start signal, and the duplication complete signal. If the server 50 receives the afore-mentioned control signal, a control signal processing is implemented according to the content of the control signal (step ST26).

In contrast, if the server 50 does not receive the afore-described control signal, the server 50 determines whether there is a disconnection request issued from the computer 120 (step ST27). If there is no disconnection request, processing goes back to step ST4 to send new image data to the computer 120 of the remote terminal 100 via the network 300. If there is a disconnection request, the server 50 stops transmitting the captured image being captured by the camcorder 20 (step ST28). Then, the server 50 determines whether there is an end request of processing (step ST29). If there is no end request, processing goes back to step ST23 to repeat the afore-described process. If there is an end request, the server 50 completes the process.

A description will now be given of the control signal processing in the above-mentioned step ST26. First, the server 50 determines whether the draw signal has been received from the remote terminal 100, as shown in FIG. 4 (step ST31). If the server 50 receives the draw signal, the server 50 drives the projector 40 to project the annotation image according to the content of the draw signal onto the target 200 (step ST32).

If the server 50 has not received the draw signal, the server 50 determines whether the duplication start signal has been received (step ST33). If the server 50 receives the duplication start signal, the exposure condition of the camcorder 20 is set to those at the time of capturing the duplication (step ST34). That is to say, the server 50 changes the exposure condition of the camcorder 20 so that the duplicated image included in the captured image captured by the camcorder 20 can be recognized and distinguished when the duplicated image is projected onto the target 200. This is because if the exposure condition of the captured image to be used for forming the duplicated image is too bright, the content of the duplicated image cannot be recognized in the captured image of the target 200 on which the duplicated image has been projected.

As a specific exposure condition, for example, it is desirable to set the exposure condition that is most suitable when the projector 40 projects nothing. With such an exposure condition, it is possible to duplicate the image without changing the brightness on the target 200 in the remote terminal 100 unless the conditions of light around the target 200 change. For instance, when the duplicated image DR1 of the notice RM is displayed on the display screen 111 of the remote terminal 100, it is possible to clearly distinguish the content of the duplicated image DR1 by setting the exposure condition most suitably at the time of forming the duplicated image. The server 50 completes the settings of the exposure condition for duplication, and then transmits the above-described exposure condition setting complete signal (step ST35) and completes the process.

If the server 50 has not received the duplication start signal in step ST33, the server 50 determines whether the duplication complete signal has been received (step ST36). If the server 50 has received the duplication complete signal, the exposure condition is returned to the initial settings (step ST37), and the process is completed.

As described heretofore, according to the present invention, it is possible to utilize the image captured by the camcorder 20 as the annotation image. This makes it possible to significantly increase the substantial kinds and contents of the annotation image and give an exact instruction from the remote site and facilitate the instruction.

In the above-mentioned embodiment, the projector has been exemplified as a projecting portion. However, the projection portion is not limited to the projector. An alternate member is applicable if the annotation image can be projected onto the target.

In the above-described embodiment, exemplified has been a duplicated image creating portion that creates the duplicated image realized on the remote terminal 100 to store on a memory of the remote terminal 100. However, the duplicated image creating portion is not limited to be stored on the remote terminal 100. only the instruction necessary for duplication may be transmitted to the server 50 from the remote terminal 100 and the duplicated image creating portion may be configured in such a manner that the duplicated image is formed and stored on the server 50.

In the above-described embodiment, the description has exemplified on the remote terminal 100 connected to the server 50 via the network 300. However, the connection of the remote terminal 100 is not limited to the afore-mentioned one. The remote terminal 100 may be connected to the server 50 by an alternate means. In addition, the remote terminal 100 may be connected to the target 200.

In the above-mentioned embodiment, the white board has been exemplarily described as the target. However, the target is not limited to the white board. All things, objects, and subjects captured by the camcorder 20 may be applicable to the target. For example, a model or prototype is also applicable to the target.

The system in accordance with an embodiment of the present invention may be applied to a comparison of multiple products (targets) having similar shapes. For example, a duplicated image of one product is created and the duplicated image is projected onto the other product to overlap it. This makes it possible to show the difference between the two. Also, it is possible to make a comparison by overlapping and shifting to a certain amount, instead of overlapping the two accurately. Further, a screen or the like may be provided to have a projected surface thereof on a position adjacent to one product so that the duplicated image of another product may be projected onto the projected surface of the screen or the like to make a_comparison. Specifically, a product having a good shape (good product) and another product having a defective shape (defective product) are projected and overlapped, thereby enabling to visually make a distinction whether the product is good or defective. In this manner, it is possible to apply to confirmation of the product whether it is good or defective. As an example of a process of comparing the products, two similar products are arranged together to capture the images thereof simultaneously. Necessary portions of the captured images are partially cut out, and a duplicated image of one of the products is created to overlap the other product. In this case, two products can be compared, yet three or more products can be compared, too. As an alternate example of the process of comparing the products, a duplicated image of one product to be used for a comparison is captured in advance before the products are compared. Then, the duplicated image is projected onto the product to be compared to overlap it. This comparison enables, for example, the product inspection of mass-produced products sequentially.

In the above-described embodiment, a description has been given of a case where the captured image of the target is partially cut for creating the duplicated image, yet the present invention is not limited to this. The whole captured image may be applicable to the captured image. A portion or whole of the target may be used as the duplicated image without change, yet the captured image may be processed, information may be newly added to the captured image, or multiple images may be combined, so the duplicated image can be created.

In the above-described remote instruction system, an exposure condition of the image capturing portion may be changed between a normal image capturing time when the target is captured by the image capturing portion and a duplicated image capturing time when the image of the target is captured to create the duplicated image, to recognize the duplicated image included in the captured image captured by the image capturing portion and projected onto the target. With the above-mentioned system, when the duplicated image is projected onto the target, the projection region on the target is brighter than any other region in which the duplicated image is not projected. If the exposure conditions are the same before and after the duplicated image is projected, it may be difficult to distinguish the duplicated image in the captured image. However, the duplicated image being projected onto the target can be recognized in the captured image. Therefore, it is also possible to recognize the duplicated image being projected onto the target on the display screen of the remote terminal.

In the above-mentioned remote instruction system, the exposure condition of the image capturing portion may be set to automatic exposure control at the normal image capturing time. With the above-mentioned system, the exposure condition is adjusted according to the brightness of the annotation image to be projected onto the target, making it possible to recognize the content of the annotation image in the captured image.

In the above-mentioned remote instruction system, the duplicated image may be created according to an operation for duplicating the captured image of the target being displayed on a display screen of the remote terminal. With the above-mentioned system, it is possible to create the duplicated image while looking at the display screen of the remote terminal.

According to the present invention, in the remote instruction system in which the captured image of the target is transmitted to the remote terminal and the annotation image is projected onto the target according to the instruction on the captured image given by the remote terminal, it is possible to give an instruction appropriately and facilitate the instruction with the annotation image.

Although a few embodiments of the present invention have been shown and described, it would be appreciated by those skilled in the art that changes may be made in these embodiments without departing from the principles and spirit of the invention, the scope of which is defined in the claims and their equivalents.

The entire disclosure of Japanese Patent Application No. 2005-175831 filed on Jun. 16, 2005 including specification, claims, drawings, and abstract is incorporated herein by reference in its entirety.

What is claimed is:

1. A remote instruction system comprising:
a controller that controls an image capturing portion to continue capturing an image of a target to transmit a captured image to a remote terminal with the image of the target being captured, and controls a projecting portion to project onto the target an annotation image according to an instruction on the captured image given by the remote terminal; and
a duplicated image creating portion that creates a duplicated image of the target on the basis of the captured image of the target to be used as the annotation image.

2. The remote instruction system as claimed in claim 1, wherein the controller changes an exposure condition of the image capturing portion between a normal image capturing time when the target is captured by the image capturing portion and a duplicated image capturing time when the image of the target is captured to create the duplicated image, to recognize the duplicated image included in the captured image captured by the image capturing portion and projected onto the target.

3. The remote instruction system as claimed in claim 2, wherein the exposure condition of the image capturing portion is set to automatic exposure control at the normal image capturing time.

4. The remote instruction system as claimed in claim 1, wherein the duplicated image creating portion creates the duplicated image according to an operation for duplication of the captured image of the target being displayed on a display screen of the remote terminal.

5. The remote instruction system as claimed in claim 1, wherein the duplicated image creating portion stores the duplicated image on a memory portion to be used as the annotation image.

6. The remote instruction system as claimed in claim 1, wherein the duplicated image creating portion cuts out a given region of the captured image of the target according to an instruction on duplication given by the remote terminal.

7. The remote instruction system as claimed in claim 1, wherein the duplicated image creating portion confirms that an exposure condition is set for a duplicated image capturing time when the image of the target is captured to create the duplicated image, creates the duplicated image from the captured image of the target to be set as the duplicated image, and outputs a duplication end signal to the controller after the duplicated image is created.

8. The remote instruction system as claimed in claim 1, wherein if the controller receives a duplication start signal from the remote terminal, the controller sets the exposure condition for a duplicated image capturing time and sends an exposure condition setting complete signal to the remote terminal, and if the controller receives a duplication complete signal from the remote terminal, the controller returns the exposure condition to an initial setting.

9. The remote instruction system as claimed in claim 1, wherein the projection portion has a field angle arranged to be substantially aligned with that of the image capturing portion on the target.

10. The remote instruction system as claimed in claim 1, wherein the target includes a white board.

11. The remote instruction system as claimed in claim 10, wherein the duplicated image of a notice provided on the white board is created to project the duplicated image onto the white board.

12. The remote instruction system as claimed in claim 1, wherein at least one target is captured and the duplicated image of one target is created to project onto and overlap said one target or another target.

13. A remote instruction method comprising:
controlling an image capturing portion to continue capturing an image of a target to transmit a captured image to a remote terminal with the image of the target being captured; controlling a projecting portion to project onto the target an annotation image according to an instruction on the captured image given by the remote terminal; a duplicated image creating portion that creates a duplicated image of the target on the basis of the captured image of the target; and
creating a duplicated image of the target on the basis of the captured image of the target to be used as the annotation image.

14. The remote instruction method as claimed in claim 13, wherein an exposure condition of the image capturing portion is changed between a normal image capturing time when the target is captured by the image capturing portion and a duplicated image capturing time when the image of the target is captured to create the duplicated image, to recognize the duplicated image included in the captured image captured by the image capturing portion and projected onto the target.
